(19) United States
(12) Patent Application Publication
(10) Pub. No.: US 2007/0108758 A1
(43) Pub. Date: May 17, 2007

(54) Biosignatures: linear diagrams for biological energy balancing

(76) Inventor: Ibrahim Fahmy Karim, (US)

Correspondence Address: BROWDY AND NEIMARK, P.L.L.C.;624 NINTH STREET, NW, SUITE 300, WASHINGTON, DC, 20001-5303, US

(21) Appl. No.: 10/585,138

(22) PCT Filed: Dec. 31, 2003
(86) PCT No.: PCT/EG03/00016

§ 371 Date: Jun. 30, 2006

(51) Int. Cl. B42D 15/00

(52) U.S. Cl. 283/115; 600/300

(57) ABSTRACT

Linear diagrams (FIGS. 1 to 247) tracing and corresponding to the functional paths of subtle energy flow within the organs of the human body to restore proper flow and energy balancing through resonance. This results in a positive effect on biological functions, either preventative or healing, and protection from environmental energy disturbances. The diagrams are activated by the body's peripheral energy field, which is channeled through the linear diagrams, and enters into resonance with the functions of the organs they correspond to. The energy balancing effect and restoration of proper energy flow within the organs can be introduced by the diagrams either by proximity to the human body, or by superimposing on a radiating energy source that reaches the biological system. These linear diagrams have been termed and copyrighted “BioSignatures” by the inventor.

BioSignatures, the present invention, are linear diagrams tracing and corresponding to the functional circuitry of subtle energy flow within the organs of the human body to restore proper flow and energy balancing by resonance. This results in a positive effect on biological functions, whether preventative or healing, and protects from environmental energy disturbances. The diagrams are activated by the body's peripheral energy field, which is channeled through the linear diagrams, and enters into resonance with the functions of the organs they represent. The energy balancing effect and restoration of proper energy flow within the organs can be introduced by the BioSignatures either by proximity to the human body, or by superimposing on a radiating energy source that reaches the body. These linear diagrams have been termed and copyrighted “BioSignatures” by the inventor.

Research has shown that all patterns on the surface of life forms such as plants, animals, insects and other living systems form an integral part of the total energy system of that life form. This pattern is related to the peripheral energy flow on the surface of the body, which usually interacts with the environment to adapt the central energy system to external changes. The existence of a central and peripheral energy system in the body is a fact that most alternative medical practices recognize and work with. This peripheral energy system includes an energy boundary around the shape of our body, similar to that found on the periphery of any geometrical shape (the earth and its atmosphere for example). The shape of the body has a sort of energy storage layer, which is the fat on the skin. The fat layer has more than an insulation function that protects the central energy from external factors it has the ability to accumulate and store information. If we put a simple shape into this information exchange layer around the physical body we will get resonance with corresponding energy patterns of any similar shape inside the body.

Matter is interchangeable with energy, so there exists an inherit energy field around any matter. Shaping that matter changes its corresponding energy field, and the qualitative effect it has when interacting with other energy fields, such as that of the human body. When two energy fields interact they communicate and modify each other through the law of resonance. This law of resonance extends to the above mentioned energy principles of shape and we see that shapes themselves can interact through resonance.

Building on this energy interaction, the science of BioSignatures was developed. BioSignatures, are linear diagrams that, by virtue of their design properties, directly balance the energy of body organs and their functions. Similar in concept to computer technology when activated by an electric current the function is determined by the design of the circuit even when reduced to a micro level. BioSignatures, on the other hand, are activated by the body's peripheral energy channeled through these special shapes that simulate the electrical path of different functions of different body organs. The energy is conducted through the linear diagram (like electricity through wires or running water along the stream of a river bed.). The flow of energy through the patterns enters into resonance with the functions of the organ they represent as similar patterns attune (much like the tuning of musical instruments) causing a harmonic amplification which restores the correct balance within the organ; this correction is instantaneous on the energy level. To manifest on the physical however, it may take longer depending on the nature of the problem and the state of the organ concerned. If the signatures are not properly designed or not needed, they do not enter into resonance with the functional energy and produce no effect. Thus, there is no possibility of harmful side effects. By balancing the energy of the immune system, a general initial cleansing effect can be produced in some cases, before the final balance is achieved.

Similar shapes enter into resonance with each other. If my stomach has a problem and I bring a model of a stomach and put it in my energy field, will this model enter into resonance with the stomach? Yes, this model is neutral; however, when it is in my energy field, then it will enter into resonance with similarly shaped organ in my body. In other words, I can put a model of an organ in resonance with an organ. With this stomach model we can only correct the peripheral energy of shape going on the periphery of the organ. We did not take into consideration all of its internal functions. Using the BioGeometry measuring techniques of qualitative physics we can then trace the energy patterns of the internal sections of the organ. For example an organ with ten functions means that there are ten patterns of motion of energy inside it that are superimposed. Each pattern is on a different layer, with a different frequency. Every pattern takes a certain shape because it performs a different function. They will all be in a way related to the primary shape but more to the internal patterns of shape within the organ, and they are of linear design in order to conduct energy. All those patterns interact together at the end and form an energy grid. So, instead of entering into resonance with only the primary shape, we go directly to each individual energy pattern. This process can go to the smallest detail even down to the DNA or genes. We now have our BioSignatures which, when placed within the peripheral energy, conduct the energy into their linear shape to form an energy pattern of the same shape that enters into resonance with corresponding body function and amplifies the energy of that corresponding organ function. This instantaneously corrects the flow of energy and balances the organ function on the energy level.

It is important to note that we are producing an energy balance of the organ function. We are not speaking of the healing of the organ on a physical level. BioSignatures have an energy balancing effect which supports other forms of orthodox medical treatments or alternative remedies.

Sometimes, when the energy is properly balanced, the body can produce its own healing, which can be instantaneous. This should not however delude us into thinking that this is a form of alternative medical treatment. It is still a form of energy balancing, which is nearer to an environmental ‘tuning’ activity that supports health. It is rather like the tuning of a musical instrument. When we look at it in this context, it is easy to understand the simple scientific concept of BioSignatures.

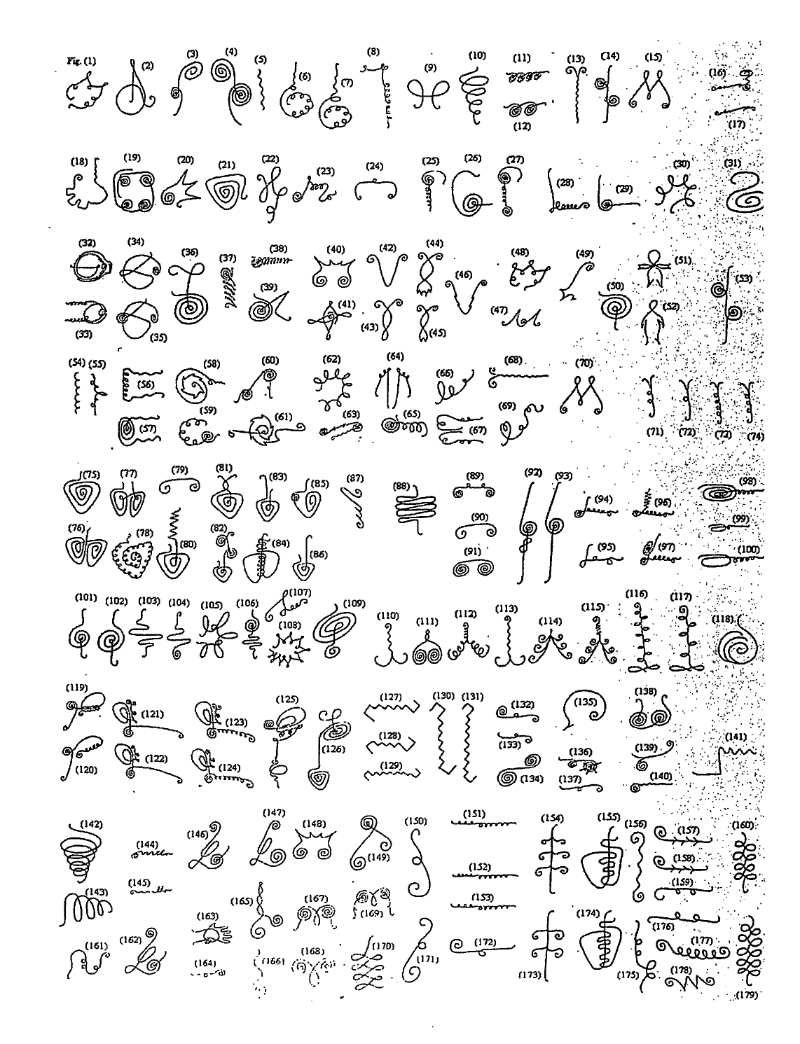

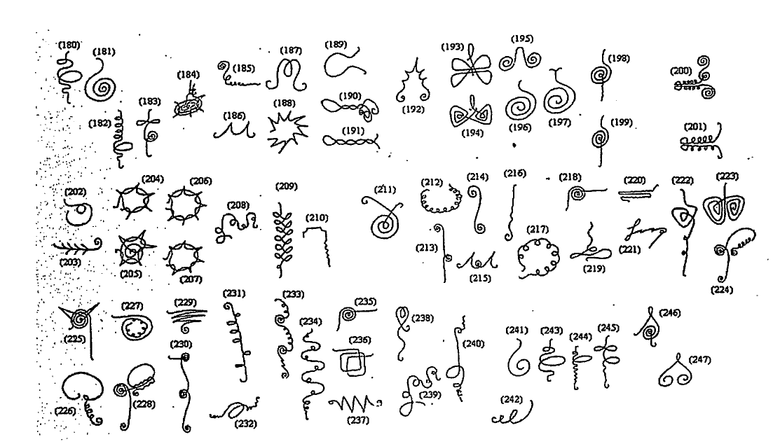

1. Linear diagrams (FIGS. 1 to 247) tracing and corresponding to the functional paths of subtle energy flow within the organs of the human body to restore proper flow and energy balancing through resonance. This resulting in a positive effect on biological functions, and protection from environmental energy disturbances.

2. Linear diagrams according to claim 1, with the same diagram/flow in different proportions.

3. Linear diagrams according to any preceding claim, termed “BioSignatures.”

4. Linear diagrams according to any preceding claim, either in two or three dimensional form.

5. Linear diagrams according to any preceding claim, any material.

6. Linear diagrams according to any preceding claim, any size.

7. Linear diagrams according to any preceding claim, used individually or in any unison.
